(19) United States
(12) Patent Application Publication
(10) Pub. No.: US 2026/0226211 A1
(43) Pub. Date: Aug. 6, 2026

(54) MULTIMODAL ETHYLENE-BASED COPOLYMER COMPOSITIONS AND PROCESSES OF PRODUCING

(71) Applicant: Dow Global Technologies LLC, Midland, MI (US)

(72) Inventors: Mari S. Rosen, Houston, TX (US); Philip P. Fontaine, Pearland, TX (US); Jerzy Klosin, Midland, MI (US); Edmund M. Carnahan, Pearland, TX (US); Alec Y. Wang, Sugarland, TX (US); Yolanda A. Daza, Lake Jackson, TX (US); Fawzi G. Hamad, Pearland, TX (US); Paul Balding, Lake Jackson, TX (US); Joana Amaral Pereira, Gent (BE)

(73) Assignee: Dow Global Technologies LLC, Midland, MI (US)

(21) Appl. No.: 19/492,430

(22) PCT Filed: Jun. 13, 2024
(86) PCT No.: PCT/US2024/033788

§ 371 Date: Dec. 11, 2025

Related U.S. Application Data
(60) Provisional application No. 63/510,779, filed on Jun. 28, 2023.

(51) Int. Cl. C08F 210/16

(52) U.S. Cl. CPC C08F 210/16

(57) ABSTRACT

Processes of making a multimodal ethylene-based copolymer. The processes include adding ethylene, at least one olefinic monomer, at least a first catalyst system, and less than 0.3 mol % hydrogen gas to a solution polymerization reactor to create an effluent feed at a reactor temperature of greater than or equal to 100° C. The effluent feed and a second catalyst system is fed to a second reactor absent fresh feed and absent hydrogen gas. At least one of the first catalyst system and the second catalyst system have a chain transfer constant of from 0.005 to 1.0. The multimodal ethylene-based copolymer comprises a high molecular weight fraction, meaning the molecular weight fraction that is greater than 500,000 g/mol, from 8% to 50% based on the total percent of the multimodal ethylene-based copolymer.

### CROSS-REFERENCE TO RELATED APPLICATIONS

This application claims the benefit of U.S. Provisional Application Ser. No. 63/510,779 filed Jun. 28, 2023, the contents of which are incorporated in their entirety herein.

### TECHNICAL FIELD

Embodiments of the present disclosure generally relate to polymer compositions and more specifically relate to multimodal ethylene-based copolymer compositions and processes of producing the same.

### BACKGROUND

The use of polyolefin compositions in industries such as packaging applications is generally known. A variety of conventional methods may be employed to produce such polyolefin compositions. Various polymerization techniques using different catalyst systems have been employed to produce such polyolefin compositions suitable for packaging applications. However, despite the research efforts in developing compositions suitable for, in some embodiments, packaging applications, there is still a need for improved polyethylene compositions suitable for packaging applications that may have a good balance of physical properties and melt strength at desired polymer composition densities.

### SUMMARY

Melt strength and processability are correlated properties of polyethylene resins. In general, a higher melt strength provides for a polyethylene resin with improved processability.

Additionally, conventional polyethylene resins produced by conventional processes typically see a tradeoff between the resin's mechanical properties and melt strength. For example, conventional radical processes, which are known to be hazardous, produce low density polyethylenes (LDPE) that typically exhibit high melt strength but have poor mechanical properties. In contrast, linear low-density polyethylenes (LLDPE) made via solution or gas phase processes typically have poor melt strength but excellent mechanical properties.

Therefore, to increase processability, some amount of LDPE may typically be blended with LLDPE in order to improve the processability and melt strength of LLDPE resins. Unfortunately, the addition of LDPE leads to decreased mechanical properties of the resulting blends when compared with pure LLDPE resin.

Accordingly, there are needs for solution polymerization processes that produce polyethylene resins that may have melt strengths comparable to polyethylene resins produced via a radical process. In particular, there are needs for solution polymerization processes that produce polyethylene resins that may have melt strengths comparable to LDPE resins produced via a radical process. Thus, there is a need to produce a high molecular weight (HMW) polyethylene copolymer and a low molecular weight (LMW) polyethylene copolymer to create multimodal ethylene-based copolymers. These multimodal ethylene-based copolymers with a HMW ethylene-based copolymer component have higher melt strengths than polyethylenes of similar melt indices without this HMW polyethylene component.

Embodiments of the present disclosure meet those needs by providing multimodal ethylene-based copolymers that comprise a bulk low molecular weight (LMW) ethylene-based component made by one catalyst or catalysts and a high molecular weight (HMW) ethylene-based component made by a different catalyst or catalysts. The multimodal ethylene-based copolymers described herein may possess long chain branching that, along with the HMW ethylene-based component, allows for melt strengths to be achieved that are comparable to or higher than various LDPEs produced via conventional processes. Consequently, the multimodal ethylene-based copolymers described herein may be used as blend components with LLDPEs in lesser amounts than what is needed for conventional LDPE resins, thereby leading to improved mechanical properties of the resulting LLDPE blends when compared to the mechanical properties in conventional LLDPE/LDPE blends. In embodiments, the multimodal ethylene-based copolymers are produced via a solution polymerization process.

Embodiments of this disclosure include a process utilizing the use of a low H₂ level. Controlling the levels of H₂ in a reactor may allow the molecular weight of the ethylene-based copolymers to be regulated. If the H₂ level is too high, the molecular weight difference between the polymers produced by the two catalysts may be diminished to the point where there is no HMW ethylene-based copolymer component (and both catalysts would be producing LMW PE) and no melt strength improvement is obtained.

Embodiments of this disclosure include processes of making a multimodal ethylene-based copolymer. In embodiments, the process includes adding ethylene, at least one olefinic monomer, at least a first catalyst system, and less than 0.3 mol % hydrogen gas to a solution polymerization reactor to create an effluent feed at a reactor temperature of greater than or equal to 150° C.; feeding the effluent feed and a second catalyst system to a second reactor absent fresh feed and absent hydrogen gas; wherein: the first catalyst system comprises a first procatalyst and a first activator; and the second catalyst system comprises a second procatalyst and optionally a second activator; at least one of the first catalyst system and the second catalyst system have a chain transfer constant from 0.005 to 1.0. The multimodal ethylene-based copolymer comprises a high molecular weight fraction, computed by measuring an area fraction of a molecular weight chromatogram obtained from absolute molecular weights from low angle light scattering greater than 500,000 g/mol, of from 8% to 50% based on the total percent of the multimodal ethylene-based copolymer.

### DETAILED DESCRIPTION

Embodiments of multimodal ethylene-based copolymer compositions and processes of producing the same will now be described. The ethylene-based polymers, of ethylene and optionally one or more co-monomers such as α-olefins, may comprise from at least 50 mole percent (mol %) monomer units derived from ethylene. All individual values and subranges encompassed by “from at least 50 mole percent” are disclosed herein as separate embodiments; for example, the ethylene based polymers may comprise at least 60 mole percent monomer units derived from ethylene; at least 70 mole percent monomer units derived from ethylene; at least 80 mole percent monomer units derived from ethylene; or from 50 to 100 mole percent monomer units derived from ethylene; or from 80 to 100 mole percent monomer units derived from ethylene.

### Processes

Embodiments of this disclosure include processes of making a multimodal ethylene-based copolymer. In embodiments, the process includes adding ethylene, at least one olefinic monomer, at least a first catalyst system, and less than 0.3 mol % hydrogen gas to a solution polymerization reactor to create an effluent feed at a reactor temperature of greater than or equal to 150° C.; feeding the effluent feed and a second catalyst system to a second reactor absent fresh feed and absent hydrogen gas; wherein: the first catalyst system comprises a first procatalyst and a first activator; and the second catalyst system comprises a second procatalyst and optionally a second activator; at least one of the first catalyst system and the second catalyst system have a chain transfer constant from 0.005 to 1.0. The multimodal ethylene-based copolymer comprises a high molecular weight fraction, computed by measuring an area fraction of a molecular weight chromatogram obtained from absolute molecular weights from low angle light scattering greater than 500,000 g/mol, of from 8% to 50% based on the total percent of the multimodal ethylene-based copolymer.

In embodiments, the multimodal ethylene-based copolymer compositions may be produced via a solution polymerization process. In embodiments, the process of making a multimodal ethylene-based copolymer may include contacting at least two olefinic monomers in the presence of a catalyst system comprising at least one low molecular weight catalyst and at least one high molecular weight catalyst in the solution polymerization reactor system.

In embodiments, the solution polymerization reactor system may include one or more reactors. In embodiments, the solution polymerization reactor system may be a single reactor system. In embodiments, the solution polymerization reactor system may be a dual reactor system. In embodiments that comprise a dual reactor system, the solution polymerization reactor system may include a first reactor and a second reactor. Such solution polymerization processes include using one or more conventional reactors such as loop reactors, isothermal reactors, adiabatic reactors, fluidized bed gas phase reactors, stirred tank reactors (such as a continuation stirred tank reactor), batch reactors in parallel, series, or any combinations thereof, for example.

In one or more embodiments, the process includes adding less than 0.3 mol % hydrogen gas to a solution polymerization reactor to create an effluent feed. In one or more embodiments, the hydrogen gas feed is from 0 to 0.27 mol %, from 0 to 0.25 mol %, from 0 to 0.23 mol %, from 0 to 0.22 mol %, from 0 to 0.20 mol %, from 0 to 0.18 mol %, from 0 to 0.15 mol %, from 0 to 0.12 mol % or from 0 to 0.10 mol %.

In embodiments, ethylene and at least one olefinic monomer may be polymerized in the presence of a catalyst to produce the multimodal ethylene-based copolymer compositions described herein. The olefinic monomer may be an α-olefin co-monomer. Typically, the α-olefin monomers have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, and 4-methyl-l-pentene. For example, the one or more αolefin co-monomers may be selected from the group consisting of propylene, 1-butene, 1hexene, and 1-octene; or in the alternative, from the group consisting of 1-hexene and 1octene. In embodiments, the α-olefin co-monomers and the process solvent may be purified with molecular sieves before introduction into the solution polymerization reactor system. The solvent, monomer, comonomers, and hydrogen may be combined and feed to the solution polymerization reactor system. Exemplary solvents include, but are not limited to, isoparaffins. For example, such solvents are commercially available under the name ISOPAR™ E from ExxonMobil Chemical. In embodiments, the combined feed may be temperature controlled to a temperature of from 5° C. to 50° C., from 5° C. to 25° C., from 5° C. to 10° C., from 10° C. to 50° C., from 10° C. to 25° C., or from 25° C. to 50° C.

In embodiments, the reactor temperature is greater than or equal to 150° C. In some embodiments, the reactor temperature is from 150° C. to 300° C. In one or more embodiments, the reactor temperature is from 150° C. to 200° C.

The catalyst systems, described in the subsequent section in more detail, are utilized in the polymerization of olefins to produce the multimodal ethylene-based copolymer compositions described herein. As stated previously, the catalyst system in the solution polymerization reactor system may comprise at least one first catalyst that produces a bulk low molecular weight (LMW) ethylene-based component and at least one second catalyst that produces a high molecular weight (HMW) ethylene-based component.

In one embodiment, the multimodal ethylene-based copolymer composition may be produced, via a solution polymerization process, wherein ethylene, and optionally one or more α-olefins, are polymerized in the presence of a first catalyst to produce a bulk low molecular weight (LMW) ethylene-based component. As used herein, “bulk” may refer to a component that makes up greater than 50% of a composition, based on the overall weight of the composition. In one or more embodiments, the first catalyst may have a first catalyst efficiency of from 1,000 kg polymer/g metal to 30,000 kg polymer/g metal. In further embodiments, the first catalyst may have a low molecular weight catalyst efficiency of from 1,000 kg polymer/g metal to 25,000 kg polymer/g metal, from 1,000 kg polymer/g metal to 20,000 kg polymer/g metal, from 1,000 kg polymer/g metal to 15,000 kg polymer/g metal, from 1,000 kg polymer/g metal to 10,000 kg polymer/g metal, from 1,000 kg polymer/g metal to 5,000 kg polymer/g metal, from 5,000 kg polymer/g metal to 25,000 kg polymer/g metal, from 5,000 kg polymer/g metal to 20,000 kg polymer/g metal, from 5,000 kg polymer/g metal to 15,000 kg polymer/g metal, from 5,000 kg polymer/g metal to 10,000 kg polymer/g metal, from 10,000 kg polymer/g metal to 25,000 kg polymer/g metal, from 10,000 kg polymer/g metal to 20,000 kg polymer/g metal, from 10,000 kg polymer/g metal to 15,000 kg polymer/g metal, from 15,000 kg polymer/g metal to 25,000 kg polymer/g metal, from 15,000 kg polymer/g metal to 20,000 kg polymer/g metal, or from 1,000 kg polymer/g metal to 25,000 kg polymer/g metal.

In one embodiment, the multimodal ethylene-based copolymer composition may be produced, via a solution polymerization process, wherein ethylene and optionally one or more α-olefins are polymerized in the presence of a second catalyst to produce the high molecular weight (HMW) ethylene-based component. In one or more embodiments, the second catalyst may have a second efficiency of from 1,000 kg polymer/g metal to 100,000 kg polymer/g metal. In further embodiments, the second catalyst may have a second efficiency of from 1,000 kg polymer/g metal to 75,000 kg polymer/g metal, from 1,000 kg polymer/g metal to 50,000 kg polymer/g metal, or from 1,000 kg polymer/g metal to 25,000 kg polymer/g metal. In further embodiments, the second catalyst may have a second efficiency of from 1,000 kg polymer/g metal to 25,000 kg polymer/g metal, from 1,000 kg polymer/g metal to 20,000 kg polymer/g metal, from 1,000 kg polymer/g metal to 15,000 kg polymer/g metal, from 1,000 kg polymer/g metal to 10,000 kg polymer/g metal, from 1,000 kg polymer/g metal to 5,000 kg polymer/g metal, from 5,000 kg polymer/g metal to 25,000 kg polymer/g metal, from 5,000 kg polymer/g metal to 20,000 kg polymer/g metal, from 5,000 kg polymer/g metal to 15,000 kg polymer/g metal, from 5,000 kg polymer/g metal to 10,000 kg polymer/g metal, from 10,000 kg polymer/g metal to 25,000 kg polymer/g metal, from 10,000 kg polymer/g metal to 20,000 kg polymer/g metal, from 10,000 kg polymer/g metal to 15,000 kg polymer/g metal, from 15,000 kg polymer/g metal to 25,000 kg polymer/g metal, from 15,000 kg polymer/g metal to 20,000 kg polymer/g metal, or from 1,000 kg polymer/g metal to 25,000 kg polymer/g metal. In one or more embodiments, the second catalyst may exhibit a second reactivity ratio of less than 20. In further embodiments, the second catalyst may exhibit a second reactivity ratio of less than 20, less than 15, or less than 10. In further embodiments, the second catalyst may exhibit a first reactivity ratio of from 10 to 20, from 10 to 15, or from 15 to 20.

In some embodiments, the multimodal ethylene-based copolymer composition may be produced, via a solution polymerization process, in a dual reactor system, for example a dual loop reactor system, wherein ethylene, and optionally one or more α-olefins, are polymerized in the presence of the low molecular weight catalyst system, in a first reactor, to produce the bulk low molecular weight (LMW) ethylene-based component and ethylene, and optionally one or more α-olefins, are polymerized in the presence of the high molecular weight catalyst system, in a second reactor, to produce the high molecular weight (HMW) ethylene-based component. Additionally, one or more cocatalysts may be present.

In some embodiments, the multimodal ethylene-based copolymer composition may be produced, via a solution polymerization process, in a dual reactor system, in which the first reactor is a continuous stir reactor and the second polymerization reactor is a non-agitated polymerization reactor, such as, for example, a non-agitated tank reactor or a tubular reactor. In one or more embodiments, the non-agitator reactor is a plug flow reactor or a piston flow reactor. The term “non-agitated reactor” refers to a reactor that does not include mechanical agitation, such as agitation by a stirrer, a mixer, a kneader, or the like. Examples of non-agitated reactors include plug flow reactors, tank reactors, and loop reactors, all without stirrers, mixers, or the like.

In embodiments, the solution polymerization reactor system may include one or more reactors that operate at a temperature greater than 150° C. In embodiments, the solution polymerization reactor system may include one or more reactors that operate at a temperature from 160° C. to 200° C., from 160° C. to 190° C., from 160° C. to 180° C., from 160° C. to 170° C., from 170° C. to 200° C., from 170° C. to 190° C., from 170° C. to 180° C., from 180° C. to 200° C., from 180° C. to 190° C., or from 190° C. to 200° C. Operating the solution polymerization reactor at elevated reactor temperatures (>150° C.) may increase production rate and decrease energy consumption while still producing the polyethylene product with an acceptable catalyst efficiency and process control.

The reactor monomer feed (ethylene) stream is pressurized via mechanical compressor to above reaction pressure at 525 psig. The solvent and comonomer (1-octene) feeds are pressurized via mechanical positive displacement pump to above reaction pressure at 525 psig.

Immediately following each fresh injection location, the feed streams are mixed with the circulating polymerization reactor contents with static mixing elements. The effluent from the polymerization reactor (containing solvent, monomer, comonomer, hydrogen, catalyst components, and molten polymer) exits the first reactor loop and passes through a control valve (responsible for maintaining the pressure of the first reactor at a specified target). As the stream exits the reactor it is contacted with water to stop the reaction. In addition, various additives such as antioxidants, could be added at this point. The stream then went through another set of static mixing elements to evenly disperse the catalyst kill and additives.

Following additive addition, the effluent (containing solvent, monomer, comonomer, hydrogen, catalyst components, and molten polymer) passed through a heat exchanger to raise the stream temperature in preparation for separation of the polymer from the other lower boiling reaction components. The stream then enters a two-stage separation and devolatization system where the polymer is removed from the solvent, hydrogen, and unreacted monomer and comonomer. The separated and devolatized polymer melt is pumped through a die specially designed for underwater pelletization, cut into uniform solid pellets, dried, and transferred into a box for storage.

### Catalyst Systems

Specific embodiments of catalyst systems that can, in one or more embodiments, be used to produce the multimodal ethylene-based copolymer compositions described herein will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

The term “independently selected” is used herein to indicate that the R groups, such as, R¹, R², R³, R⁴, and R⁵ can be identical or different (e.g., R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. These definitions are intended to supplement and illustrate, not preclude, the definitions known to those of skill in the art.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₄₀)alkyl is an alkyl group having from 1 to 40 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₄₀)alkyl substituted with exactly one group R^{S}, where R^{S} is phenyl (—C₆H₅)” may contain from 7 to 46 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or function group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent.

The term “—H” means a hydrogen or hydrogen radical that is covalently bonded to another atom. “Hydrogen” and “—H” are interchangeable, and unless clearly specified mean the same thing.

The terms “halogen atom,” “halogen,” “halide,” “saturated,” “unsaturated,” ““(C₁-C₅₀)hydrocarbyl,” “(C₁-C₅₀)alkyl,” “(C₁-C₁₈)alkyl,” “(C₆-C₅₀)aryl,” “(C₃-C₅₀)cycloalkyl,” “(C₁-C₅₀)alkylene,” “heteroatom,” and “(C₁-C₅₀)heteroalkyl” are as defined in a patent application having a publication number WO2020185494A1.

According to some embodiments, a catalyst system for producing a the multimodal ethylene-based copolymer composition includes a metal-ligand complex according to formula (I):

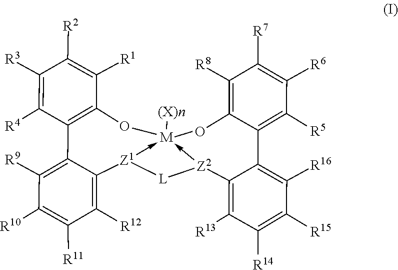

In formula (I), M is a metal chosen from scandium, titanium, zirconium, hafnium, or lanthanide metals, the metal being in a formal oxidation state of +2, +3, or +4; n is 0, 1, or 2; when n is 1, X is a monodentate ligand or a bidentate ligand; when n is 2, each X is a monodentate ligand and is the same or different; the metal-ligand complex is overall charge-neutral; each Z is independently chosen from —O—, —S—, —N(R^{N})—, or —P(R^{P})—; L is (C₁-C₄₀)hydrocarbylene or (C₁-C₄₀)heterohydrocarbylene, wherein the (C₁-C₄₀)hydrocarbylene has a portion that comprises a 1-carbon atom to 10-carbon atom linker backbone linking the two Z groups in Formula (I) (to which L is bonded) or the (C₁-C₄₀)heterohydrocarbylene has a portion that comprises a 1-atom to 10-atom linker backbone linking the two Z groups in Formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is O, S, S(O), S(O)2, Si(R^{C})2, Ge(R^{C})2, P(R^{C}), or N(R^{C}), wherein independently each R^{C} is (C₁-C₃₀)hydrocarbyl or (C₁-C₃₀)heterohydrocarbyl; R¹ and R⁸ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{c}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, and radicals having formula (II), formula (III), or formula (IV):

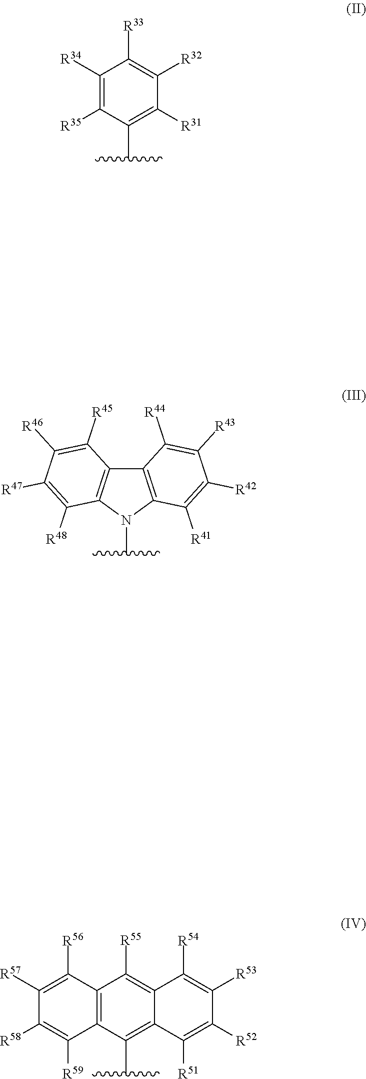

In formulas (II), (III), and (IV), each of R³¹⁻³⁵, R⁴¹⁻⁴⁸, or R⁵¹⁻⁵⁹ is independently chosen from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N═CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, or —H, provided at least one of R¹ or R⁸ is a radical having formula (II), formula (III), or formula (IV).

In formula (I), each of R²⁻⁴, R⁵⁻⁷, and R⁹⁻¹⁶ is independently selected from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N═CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, halogen, and —H.

In some embodiments, the multimodal ethylene-based copolymer composition is formed using a first catalyst according to formula (I) in a first reactor and a different catalyst according to formula (I) in a second reactor.

In one or more embodiments, the first catalyst system or the second catalyst system are capable of producing a polymer with a native molecular weight of greater than 100,000 g/mol. In some embodiments, the other of the first catalyst system or the second catalyst system (which is not capable of producing a polymer of greater than 100,000 g/mol) is capable of producing a polymer with a native molecular weight of less than 80,000 g/mol. The polymer native molecular weight is measured in a single 1 Gal reactor in the presence of 1250 grams of ISOPAR-E, with an ethylene pressure of 320 psi, 60 g of 1-octene, 0 H₂ and at a reactor temperature of at least 160° C. The term “native molecular weight” refers to the weight average molecular weight of the polymer produced by a catalyst in the absence of hydrogen.

In various embodiments, the first catalyst system is capable of producing a first polymer having a native molecular weight and the second catalyst system is capable of producing a second polymer having a native molecular weight with a difference of at least 80,000 g/mol from the native molecular weight of the first polymer. In some embodiments, the difference in the molecular weight of the first polymer and second polymer is from 80,000 g/mol to 2,000,000 g/mol. In some embodiments, the difference in the molecular weight of the first polymer and second polymer is at least 90,000 g/mol, at least 100,000 g/mol, at least 120,000 g/mol, or at least 150,000 g/mol. The polymer native molecular weight is measured in a single 1 Gal reactor in the presence of 1250 grams of ISOPAR-E, with an ethylene pressure of 320 psi, 60 g of 1-octene, 0 H₂, and at a reactor temperature of at least 160° C.

### Co-Catalyst Component

The catalyst system comprising a metal-ligand complex of formula (I) may be rendered catalytically active by any technique known in the art for activating metal-based catalysts of olefin polymerization reactions. For example, the system comprising a metal-ligand complex of formula (I) may be rendered catalytically active by contacting the complex to, or combining the complex with, an activating co-catalyst. Suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activators (co-catalysts) include Group 13 metal compounds containing from 1 to 3 (C₁-C₂₀)hydrocarbyl substituents as described herein. In one embodiment, Group 13 metal compounds are tri((C₁-C₂₀)hydrocarbyl)-substituted-aluminum or tri((C₁-C₂₀)hydrocarbyl)-boron compounds. In embodiments, Group 13 metal compounds are tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating co-catalyst is a tris((C₁-C₂₀)hydrocarbyl borate (e.g. trityl tetrafluoroborate) or a tri((C₁-C₂₀)hydrocarbyl)ammonium tetra((C₁-C₂₀)hydrocarbyl)borane (e.g. bis(octadecyl)methylammonium tetrakis(pentafluorophenyl)borane). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

Combinations of neutral Lewis acid activators (co-catalysts) include mixtures comprising a combination of a tri((C₁-C₄)alkyl)aluminum and a halogenated tri((C₆-C₁₈)aryl)boron compound, especially a tris(pentafluorophenyl)borane. Embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] are from 1:1:1 to 1:10:30, in embodiments, from 1:1:1.5 to 1:5:10

The catalyst system comprising the metal-ligand complex of formula (I) may be activated to form an active catalyst composition by combination with one or more co-catalysts, for example, a cation forming co-catalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to: modified methyl aluminoxane (MMAO), bis(hydrogenated tallow alkyl)methyl, tetrakis(pentafluorophenyl)borate(1⁻) amine, and combinations thereof.

In some embodiments, one or more of the foregoing activating co-catalysts are used in combination with each other. An especially preferred combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. In some embodiments, the ratio is at least 1:5000, in some embodiments, at least 1:1000; and 10:1 or less, and in some embodiments, 1:1 or less. When an alumoxane alone is used as the activating co-catalyst, preferably the number of moles of the alumoxane that are employed is at least 100 times the number of moles of the metal-ligand complex of formula (I). When tris(pentafluorophenyl)borane alone is used as the activating co-catalyst, in some embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1. The remaining activating co-catalysts are generally employed in approximately mole quantities equal to the total mole quantities of one or more metal-ligand complexes of formula (I).

### Compositions

It was discovered that by performing processes as described above, multimodal ethylene-based copolymer compositions with improved melt strength can be produced. Properties of the multimodal ethylene-based copolymer composition according to embodiments disclosed and described herein will now be provided. It should be understood that by modifying the various process conditions described above embodiments of the multimodal ethylene-based copolymer composition with differing and desirable properties can be produced. Although the properties listed below are recited in separate paragraphs, it should be understood that any property from any paragraph below may be combined with any other property from any paragraph below by modifying the various process conditions discussed above. Therefore, the multimodal ethylene-based copolymer composition having any combination of various properties listed below are envisioned and can be produced, according to embodiments.

In one or more embodiments, the multimodal ethylene-based copolymer composition may have a density of 0.900 g/cm³ to 0.940 g/cm³. For example, embodiments of the presently-disclosed multimodal ethylene-based copolymer composition may have densities of from 0.900 g/cm³ to 0.925 g/cm³, from 0.900 g/cm³ to 0.920 g/cm³, from 0.900 g/cm³ to 0.918 g/cm³, from 0.900 g/cm³ to 0.916 g/cm³, from 0.900 g/cm³ to 0.914 g/cm³, from 0.900 g/cm³ to 0.912 g/cm³, from 0.900 g/cm³ to 0.910 g/cm³, from 0.900 g/cm³ to 0.908 g/cm³, from 0.900 g/cm³ to 0.906 g/cm³, from 0.900 g/cm³ to 0.904 g/cm³, from 0.900 g/cm³ to 0.902 g/cm³, from 0.902 g/cm³ to 0.920 g/cm³, from 0.902 g/cm³ to 0.918 g/cm³, from 0.902 g/cm³ to 0.916 g/cm³, from 0.902 g/cm³ to 0.914 g/cm³, from 0.902 g/cm³ to 0.912 g/cm³, from 0.902 g/cm³ to 0.910 g/cm³, from 0.902 g/cm³ to 0.908 g/cm³, from 0.902 g/cm³ to 0.906 g/cm³, from 0.902 g/cm³ to 0.904 g/cm³, from 0.904 g/cm³ to 0.920 g/cm³, from 0.904 g/cm³ to 0.918 g/cm³, from 0.904 g/cm³ to 0.916 g/cm³, from 0.904 g/cm³ to 0.914 g/cm³, from 0.904 g/cm³ to 0.912 g/cm³, from 0.904 g/cm³ to 0.910 g/cm³, from 0.904 g/cm³ to 0.908 g/cm³, from 0.904 g/cm³ to 0.906 g/cm³, from 0.906 g/cm³ to 0.920 g/cm³, from 0.906 g/cm³ to 0.918 g/cm³, from 0.906 g/cm³ to 0.916 g/cm³, from 0.906 g/cm³ to 0.914 g/cm³, from 0.906 g/cm³ to 0.912 g/cm³, from 0.906 g/cm³ to 0.910 g/cm³, from 0.906 g/cm³ to 0.908 g/cm³, from 0.908 g/cm³ to 0.920 g/cm³, from 0.908 g/cm³ to 0.918 g/cm³, from 0.908 g/cm³ to 0.916 g/cm³, from 0.908 g/cm³ to 0.914 g/cm³, from 0.908 g/cm³ to 0.912 g/cm³, from 0.908 g/cm³ to 0.910 g/cm³, from 0.910 g/cm³ to 0.920 g/cm³, from 0.910 g/cm³ to 0.918 g/cm³, from 0.910 g/cm³ to 0.916 g/cm³, from 0.910 g/cm³ to 0.914 g/cm³, from 0.910 g/cm³ to 0.912 g/cm³, from 0.912 g/cm³ to 0.920 g/cm³, from 0.912 g/cm³ to 0.918 g/cm³, from 0.912 g/cm³ to 0.916 g/cm³, from 0.912 g/cm³ to 0.914 g/cm³, from 0.914 g/cm³ to 0.920 g/cm³, from 0.914 g/cm³ to 0.918 g/cm³, from 0.914 g/cm³ to 0.916 g/cm³, from 0.916 g/cm³ to 0.920 g/cm³, from 0.916 g/cm³ to 0.918 g/cm³, from 0.918 g/cm³ to 0.920 g/cm³, or any combination of these ranges.

In one or more embodiments, the multimodal ethylene-based copolymer composition may have a melt index (I₂) of from 0.50 g/10 minutes (g/10 min) to 10.0 g/10 min when measured according to ASTM D-1238 at 190° C. and 2.16 kg. In one or more embodiments, the multimodal ethylene-based copolymer composition may have a melt index (I₂) of from 0.5 g/10 min to 10.0 g/10 min, from 0.5 g/10 min to 9.0 g/10 min, from 0.5 g/10 min to 8.0 g/10 min, from 0.5 g/10 min to 7.0 g/10 min, from 0.5 g/10 min to 6.0 g/10 min, from 0.5 g/10 min to 5.0 g/10 min, from 0.5 g/10 min to 4.0 g/10 min, from 0.5 g/10 min to 3.0 g/10 min, from 0.5 g/10 min to 2.0 g/10 min, from 0.5 g/10 min to 1.0 g/10 min, from 1.0 g/10 min to 10.0 g/10 min, from 1.0 g/10 min to 9.0 g/10 min, from 1.0 g/10 min to 8.0 g/10 min, from 1.0 g/10 min to 7.0 g/10 min, from 1.0 g/10 min to 6.0 g/10 min, from 1.0 g/10 min to 5.0 g/10 min, from 1.0 g/10 min to 4.0 g/10 min, from 1.0 g/10 min to 3.0 g/10 min, from 1.0 g/10 min to 2.0 g/10 min, from 2.0 g/10 min to 10.0 g/10 min, from 2.0 g/10 min to 9.0 g/10 min, from 2.0 g/10 min to 8.0 g/10 min, from 2.0 g/10 min to 7.0 g/10 min, from 2.0 g/10 min to 6.0 g/10 min, from 2.0 g/10 min to 5.0 g/10 min, from 2.0 g/10 min to 4.0 g/10 min, from 2.0 g/10 min to 3.0 g/10 min, from 3.0 g/10 min to 10.0 g/10 min, from 3.0 g/10 min to 9.0 g/10 min, from 3.0 g/10 min to 8.0 g/10 min, from 3.0 g/10 min to 7.0 g/10 min, from 3.0 g/10 min to 6.0 g/10 min, from 3.0 g/10 min to 5.0 g/10 min, from 3.0 g/10 min to 4.0 g/10 min, from 4.0 g/10 min to 10.0 g/10 min, from 4.0 g/10 min to 9.0 g/10 min, from 4.0 g/10 min to 8.0 g/10 min, from 4.0 g/10 min to 7.0 g/10 min, from 4.0 g/10 min to 6.0 g/10 min, from 4.0 g/10 min to 5.0 g/10 min, from 5.0 g/10 min to 10.0 g/10 min, from 5.0 g/10 min to 9.0 g/10 min, from 5.0 g/10 min to 8.0 g/10 min, from 5.0 g/10 min to 7.0 g/10 min, from 5.0 g/10 min to 6.0 g/10 min, from 6.0 g/10 min to 10.0 g/10 min, from 6.0 g/10 min to 9.0 g/10 min, from 6.0 g/10 min to 8.0 g/10 min, from 6.0 g/10 min to 7.0 g/10 min, from 7.0 g/10 min to 10.0 g/10 min, from 7.0 g/10 min to 9.0 g/10 min, from 7.0 g/10 min to 8.0 g/10 min, from 8.0 g/10 min to 10.0 g/10 min, from 8.0 g/10 min to 9.0 g/10 min, from 9.0 g/10 min to 10.0 g/10 min, or any combination of these ranges, when measured according to ASTM D-1238 at 190° C. and 2.16 kg.

According to embodiments, the multimodal ethylene-based copolymer composition may have a molecular weight distribution, expressed as the ratio of the weight average molecular weight to number average molecular weight (Mw/Mn), in the range of from 2.0 to 6.0. For example, the multimodal ethylene-based copolymer composition may have a molecular weight distribution of from 2.0 to 5.5, 2.0 to 5.0, 2.0 to 4.5, 2.0 to 4.0, 2.0 to 3.5, 2.0 to 3.0, 2.0 to 2.5, 2.5 to 6.0, 3.0 to 5.5, 3.0 to 5.0, 3.0 to 4.5, 3.0 to 4.0, 3.0 to 3.5, 3.5 to 6.0, 3.5 to 5.5, 3.5 to 5.0, 3.5 to 4.5, 3.5 to 4.0, 4.0 to 6.0, 4.0 to 5.5, 4.0 to 5.0, 4.0 to 4.5, 4.5 to 6.0, 4.5 to 5.5, 4.5 to 5.0, 5.0 to 6.0, 5.0 to 5.5, or 5.5 to 6.0, or any combination of these ranges. As presently described, the molecular weight distribution may be calculated according to gel permeation chromatography (GPC) techniques as described herein.

According to embodiments, the multimodal ethylene-based copolymer composition may have an activation energy (Ea) of the composition as determined from dynamic mechanical analysis may be greater than 30 kJ/mol. The activation energy is calculated from rheology time-temperature superposition viscosity data obtained from melt rheology frequency sweeps. These measurements were performed using TA Instruments Advanced Rheometric Expansion System (ARES) equipped with 25 mm parallel plates using nitrogen pure. Linear viscoelastic response was measured at three different temperatures 150° C., 190° C., and 230° C., using frequencies of 0.1-500 rad/s., 0.1-100 rad/s, and 0.01-100 rad/s, respectively. Strain was altered based on transducer torque output, making sure torque remained with acceptable range. The stress response was analyzed in terms of amplitude and phase, from which the storage and loss moduli and dynamic melt viscosity were calculated. The temperature dependence of linear viscoelastic curve can be predicted by shifting the modulus curves across the frequency axis (X-axis) against a reference using sets of shift factors. This concept is generally known as time-temperature superposition. This technique involves shifting curves at different temperatures in such a way that they overlap and form a single curve, also known as the master curve. The shift factors were generated using RepTate software. Reference temperature was chosen at 190° C. The Arrhenius equation associates the horizontal shift factors to the activation energy and a reference temperature according to the following equation:

$$\text{?} = \text{?} \qquad ( EQ . 1 )$$

$$\text{?} \text{indicates text missing or illegible when filed}$$

In further embodiments, the multimodal ethylene-based copolymer compositions may have an activation energy (Ea) of the composition as determined from dynamic mechanical analysis may be from 30 kJ/mol to 60 kJ/mol, from 30 kJ/mol to 50 kJ/mol, from 30 kJ/mol to 40 kJ/mol, from 40 kJ/mol to 60 kJ/mol, from 40 kJ/mol to 50 kJ/mol, or from 50 kJ/mol to 60 kJ/mol.

According to embodiments, the multimodal ethylene-based copolymer composition may have a melt strength (MS) that satisfies the following equation 1:

$$M S \geq \frac{x}{{I}_{2}} + y \qquad ( EQ . 2 )$$

In Equation 2, x is equal to 15, y is greater than or equal tot, and 12 is a melt index of the copolymer measured according to ASTM 1238 at 2.16 kg and 190° C. According to one or more embodiments, the multimodal ethylene-based copolymer composition may have a melt strength of at least 5 centiNewtons (cN). In further embodiments, the multimodal ethylene-based copolymer composition may have a melt strength of from 5 cN to 50 cN, from 5 cN to 45 cN, from 5 cN to 40 cN, from 5 cN to 35 cN, from 5 cN to 30 cN, from 5 cN to 25 cN, from 5 cN to 20 cN, from 5 cN to 15 cN, from 5 cN to 10 cN, from 10 cN to 50 cN, from 10 cN to 45 cN, from 10 cN to 40 cN, from 10 cN to 35 cN, from 10 cN to 30 cN, from 10 cN to 25 cN, from 10 cN to 20 cN, from 10 cN to 15 cN, from 15 cN to 50 cN, from 15 cN to 45 cN, from 15 cN to 40 cN, from 15 cN to 35 cN, from 15 cN to 30 cN, from 15 cN to 25 cN, from 15 cN to 20 cN, from 20 cN to 50 cN, from 20 cN to 45 cN, from 20 cN to 40 cN, from 20 cN to 35 cN, from 20 cN to 30 cN, from 20 cN to 25 cN, from 25 cN to 50 cN, from 25 cN to 45 cN, from 25 cN to 40 cN, from 25 cN to 35 cN, from 25 cN to 30 cN, from 30 cN to 50 cN, from 30 cN to 45 cN, from 30 cN to 40 cN, from 30 cN to 35 cN, from 35 cN to 50 cN, from 35 cN to 45 cN, from 35 cN to 40 cN, from 40 cN to 50 cN, from 40 cN to 45 cN, or from 45 cN to 50 cN.

In embodiments, the multimodal ethylene-based copolymer composition may have a ratio of viscosity measured at 0.1 radians/second and 190° C. to viscosity measured at 100 radians/second and 190° C. (V0.1/V100), as determined by dynamic mechanical analysis, of greater than 5. In further embodiments, the multimodal ethylene-based copolymer composition may have a (V0.1/V100), as determined by dynamic mechanical analysis, of from 5 to 30, from 5 to 25, from 5 to 20, from 5 to 15, from 5 to 10, from 10 to 30, from 10 to 25, from 10 to 20, from 10 to 15, from 15 to 30, from 15 to 25, from 15 to 20, from 20 to 30, from 20 to 25, or from 25 to 30.

In embodiments, the cumulative distribution fractions (CDF) for light scattering analysis (CDF_{LS}) at a molecular weight greater than 500,000 g/mol is greater than or equal to 8%. In one or more embodiments, the molecular weight greater than 500,000 g/mol is from 8% to 50%, 10% to 50%, 20% to 50%, 30% to 50%, or 20% to 40% based on the total percent of the multimodal ethylene-based copolymer.

In embodiments, the multimodal ethylene-based copolymer composition may have a high molecular weight fraction, computed by measuring an area fraction of a low angle light scattering (LALLS) detector chromatogram greater than 500,000 g/mol, of from 8% to 50%. In embodiments, the high molecular weight fraction, computed by measuring an area fraction of a low angle light scattering (LALLS) detector chromatogram greater than 500,000 g/mol, may be from 8% to 40%, from 8% to 30%, from 10% to 50%, from 10% to 40%, from 10% to 30%, from 20% to 50%, from 20% to 40%, from 20% to 30%, from 30% to 50%, from 30% to 40%, or from 40% to 50%.

In embodiments, the multimodal ethylene-based copolymer composition may have a low molecular weight fraction, computed by measuring an area fraction of a low angle light scattering (LALLS) detector chromatogram less than 500,000 g/mol of greater than 50%. In embodiments, the low molecular weight fraction, computed by measuring an area fraction of a low angle light scattering (LALLS) detector chromatogram less than 500,000 g/mol may be from 50% to 92%, from 50% to 90%, from 50% to 80% from 50% to 70%, from 50% to 60%, from 60% to 92%, from 60% to 90%, from 60% to 80%, from 60% to 70%, from 70% to 92%, from 70% to 90%, from 70% to 80%, from 80% to 92%, from 80% to 90%, or from 90% to 92%. Traditionally, it was thought that having as much high molecular weight material as possible was ideal because high molecular weight would lead to higher levels of entanglements that improve the properties of the LLDPE. Accordingly, low molecular weight material was kept to a minimum. However, the multimodal ethylene-based copolymer compositions according to embodiments disclosed and described herein exhibit unique and unexpected characteristics compared to commercially available LDPE products when the high molecular weight fraction, computed by measuring an area fraction of a low angle light scattering (LALLS) detector chromatogram greater than 500,000 g/mol is from 8% to 50%.

The multimodal ethylene-based copolymer compositions may further comprise one or more additives. Such additives include, but are not limited to, antistatic agents, color enhancers, dyes, lubricants, pigments, primary antioxidants, secondary antioxidants, processing aids, UV stabilizers, and combinations thereof. The multimodal ethylene-based copolymer compositions may contain any amounts of additives. The multimodal ethylene-based copolymer compositions may compromise from about 0 to about 10 percent by the combined weight of such additives, based on the total weight of the multimodal ethylene-based copolymer compositions. The multimodal ethylene-based copolymer compositions may further comprise fillers, which may include, but are not limited to, organic or inorganic fillers. The multimodal ethylene-based copolymer compositions may contain from about 0 to about 20 weight percent fillers such as, for example, calcium carbonate, talc, or Mg(OH)₂, based on the total weight of the multimodal ethylene-based copolymer compositions. The multimodal ethylene-based copolymer compositions may further be blended with one or more polymers to form a blend.

### Test Methods

Unless otherwise indicated herein, the following analytical methods are used in describing aspects of the present disclosure:

### Melt Index

Melt indices I₂ (or I2) and I₁₀ (or I10) of polymer samples were measured in accordance to ASTM D-1238 (method B) at 190° C. and at 2.16 kg and 10 kg load, respectively. Their values are reported in g/10 min.

### Density

Samples for density measurement were prepared according to ASTM D4703. Measurements were made, according to ASTM D792, Method B, within one hour of sample pressing.

### Triple Detector Gel Permeation Chromatography (GPC)

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 160° Celsius and the column and detector compartment were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 3. Processing of the flow marker peak was done via the PolymerChar GPCOne™ Software. Acceptable flowrate correction is such that the effective flowrate should be within +/−0.5% of the nominal flowrate.

$${Flowrate}_{( effective )} = {Flowrate}_{( nominal )} * ( {RV}_{( FM Calibrated )} / {RV}_{( FM Sample )} ) \qquad ( EQ . 3 )$$

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475 (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn_{(Abs)} and Mz_{(Abs)} are be calculated according to equations 4-6 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ . 4 )$$

$$Mw ( Abs ) = \frac{{\sum }^{i} {IR}_{i} \times {M}_{{Absolute}_{i}}}{{\sum }^{i} {IR}_{i}} \qquad ( EQ . 5 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} \qquad ( EQ . 6 )$$

### CDF Calculation Method

Calculation of the cumulative detector fraction (CDF_{LS}) for the low-angle laser light scattering (LALLS) detector is done using the baseline subtracted peak height (H) of the absolute molecular weight chromatogram. Those values are summed over the entire chromatogram from high to low molecular weight (low to high retention volume, RV) at each data slice (j), essentially integrating the area of the chromatogram. A fraction (or percentage if multiplied by 100) of the entire molecular weight chromatogram is obtained by ratioing values greater than or equal to 500,000 g/mol to the lowest RV compared to the entire chromatogram, Equation 7:

$$C D {F}_{L S \geq 500 , 000 M W} = \frac{{\sum }_{j = RV at Lowest Integrated Volume}^{j = RV at 500 , 000 MW} Hj}{{\sum }_{j = RV at Lowest Integrated Volume}^{j = RV at Highest Integrated Volume} Hj} \qquad ( EQ . 7 )$$

### Procedure for NMR End Group Analysis Including Vinyl Count Determination

To determine vinyl count, approximately 7 mg of polymer sample was loaded into a 5 mm NMR tube with 0.6 ml tetrachloroethane-d₂ with 0.008 M chromium(III) acetylacetonate. The tube was purged with N₂, and the cap was secured with Teflon tape. The prepared sample tube was heated in a heating block set at 125° C. and repeatedly vortexed until a homogeneous solution was achieved evidenced by consistent flow when the tube was tipped horizontally. The finished sample was inserted into a Bruker AVANCE 600 MHz system equipped with a 10 mm high-temperature cryo-probe set at 120° C. The acquisition parameters for the ¹H NMR spectra are: 90 degree pulse, 1.8 second acquisition time, 10 seconds relaxation delay, center of spectrum set at 2 ppm, spectral width of 20 ppm and 128 scans for signal averaging. The resulting raw FID was exponential multiplied, Fourier transformed, phased, baseline corrected, and integrated using MNOVA software.

### Melt Strength

Melt Strength testing was conducted on either Rheotester 2000 or Rheograph 25 capillary rheometers paired with a rheotens model 71.97, all of which were manufacture by Göttfert. The die used for testing has a diameter of 2 mm, length of 30 mm and entry angle of 180 degrees. Each test was performed isothermally at 190 degrees Celsius, commonly.

During the test, the sample, in pellet form, was loaded into the capillary barrel and allowed to equilibrate at the testing temperature for 10 min. After which, the piston inside the barrel applies a steady force on the molten sample to achieve an apparent wall shear rate of 38.16 s-1, and the melt is extruded through the die with an exit velocity of approximately 9.7 mm/s. Located 100 mm below the die exit, the extrudate is guided through the wheel pairs of the rheotens, which both accelerate at a constant rate of 2.4 mm/s2 and measures the extrudate's response to the applied extensional force. Please note that the rheotens wheel pairs are serrated and are spaced 0.4 mm apart. The results of this testing were documented into plots of force with respect to rheotens wheel speed using the RtensEvaluations2007 excel macros. For analysis, the force at which fracture occurred in the melt is referred to as the melt strength of the material and the corresponding rheotens wheel speed at fracture is considered the drawability limit.

### DMS Frequency Sweep

For preparation, test samples were initially placed into a 1.5 in. diameter chase of thickness 3.10 mm and compression molded at a pressure of 25,000 lbs for 6.5 min. at 190 degrees Celsius with a Carver Hydraulic Press (Model #4095.4NE2003). After cooling to room temperature, the sample is extracted to await rheological testing.

The DMS (dynamic mechanical spectroscopy) frequency sweep is conducted using 25 mm parallel plates at frequencies ranging from 0.01 to-100 rad/s, 0.1 to 100 rad/s, and 0.1 t to 500 rad/s at 150 degrees C., 190 degrees C., and 230 degrees C., respectively. Test gap separating the plates is 1.8 mm and a strain that satisfies linear viscoelastic conditions is utilized, typically 10% strain. Each test is conducted under nitrogen atmosphere and isothermal conditions. To initiate the DMS test, the rheometer oven is first allowed to equilibrate at the desired testing temperature for at least 30 min before loading the sample into the test geometry. The sample is then equilibrated in the oven, with the door closed, for 1 min. The test gap is then set to 1.8 mm, and the sample is allotted 5 min. to relax the resulting normal force. Afterwards, the oven is quickly opened, and the sample is trimmed so that no bulge is present. The DMS measurement is then initiated after reclosing the oven. During the test, the shear elastic modulus (G′), viscous modulus (G″) and complex viscosity are measured.

All DMS frequency tests are conducted on either ARES-G2 or DHR-3 rheometers, both of which were manufactured by TA Instruments. Data analyses are conducted via TA Instruments TRIOS software.

### Procedure for Polymerization in a Continuous Reactor: Setup 1

Raw materials (ethylene, 1-octene) and the process solvent (a narrow boiling range high-purity isoparaffinic solvent trademarked SBP 100-140 or Isopar-E commercially available from Shell and ExxonMobil Corporation) are purified with molecular sieves before introduction into the reaction environment. Hydrogen is supplied in pressurized cylinders as a high purity grade and is not further purified. The reactor monomer feed (ethylene) stream is pressurized via mechanical compressor to above reaction pressure. The solvent and comonomer (1-octene) feed are pressurized via a mechanical positive displacement pump to above reaction pressure. MMAO-3A or MMAO-7, commercially available from Nouryon, was used as an impurity scavenger and/or catalyst activator. The individual catalyst components (precatalyst or cocatalyst) were manually batch diluted to specified component concentrations with purified solvent (Isopar E or SBP 100-140) and pressured to above reaction pressure. The cocatalyst is [HNMe(C₁₈H₃₇)]₂ [B(C₆F₅)₄], commercially available from Boulder Scientific, and is used at a 1.2 ratio to catalyst metal unless otherwise specified. All reaction feed flows were measured with mass flow meters and independently controlled with computer automated valve control systems.

The continuous solution polymerizations were carried out in one or more of a CSTR, loop, and/or a plug flow reactor. The CSTR and loop reactors have independent control of all fresh solvent, monomer, comonomer, hydrogen, and catalyst component feeds when specified. A fresh feed for the second reactor may be absent (i.e. fresh solvent, monomers, comonomers and hydrogen may not be added to the second reactor). The plug flow reactor has independent control of catalyst component feeds. The combined solvent, monomer, comonomer and hydrogen feed to the reactors is temperature controlled to anywhere between 5° C. to 50° C. and typically 25° C. The fresh comonomer feed to the polymerization reactor is fed in with the solvent feed. The fresh solvent feed is controlled typically with each injector receiving half of the total fresh feed mass flow. The cocatalyst is fed based on a calculated specified molar ratio to the procatalysts. Immediately following each fresh injection location, the feed streams are mixed with the circulating polymerization reactor contents with static mixing elements. The ratio of the catalyst feeds is adjusted to obtain the desired polymer MI, density, and melt strength. The effluent from the polymerization reactor system (containing solvent, monomer, comonomer, hydrogen, catalyst components, and molten polymer) exits and passes through a control valve (responsible for maintaining the pressure of the reactor system at a specified target). As the stream exits the reactor it is contacted with water to stop the reaction. In addition, various additives, such as antioxidants, could be added at this point. The stream then goes through another set of static mixing elements to evenly disperse the catalyst kill and additives.

Following additive addition, the effluent (containing solvent, monomer, comonomer, hydrogen, catalyst components, and molten polymer) passes through a heat exchanger to raise the stream temperature in preparation for separation of the polymer from the other lower boiling reaction components. The stream then entered a two-stage separation and devolatization system where the polymer was removed from the solvent, hydrogen, and unreacted monomer and comonomer. The separated and devolatized polymer melt was pumped through a die specially designed for underwater pelletization, cut into uniform solid pellets, dried, and transferred into a box for storage.

### Procedure for Polymerization in a Continuous Reactor: Setup 2

All raw materials (monomer and comonomer) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressured to above reaction pressure. All reaction feed flows are measured with mass flow meters and independently controlled with computer automated valve control systems.

A two reactor system is used in a series configuration. The first reactor is a continuous solution polymerization reactor consisting of a liquid full, adiabatic, continuously stirred tank reactor (CSTR). Independent control of all fresh solvent, monomer, comonomer, hydrogen, and catalyst component feeds is possible. The total fresh feed stream to the second reactor (solvent, monomer, comonomer, and hydrogen) is temperature controlled to maintain a single solution phase by passing the feed stream through a heat exchanger. The total fresh feed to the second polymerization reactor is injected into the reactor at one location. The catalyst components are injected into the second polymerization reactor separate from the fresh feed. The primary catalyst component feed is computer controlled to maintain the reactor monomer conversion at the specified value. The cocatalyst component(s) is/are fed based on molar ratios to the primary catalyst component. Mixing of the second reactor may be provided by an agitator. The effluent from the first polymerization reactor (containing solvent, monomer, comonomer, hydrogen, catalyst components, and polymer) exits the first reactor loop and is added to the second reactor separate from the optional fresh feed and separate from the catalyst feed components.

The second reactor is a continuous solution polymerization reactor consisting of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the first reactor (solvent, monomer, comonomer, and hydrogen) is temperature controlled to maintain a single solution phase by passing the feed stream through a heat exchanger. The total fresh feed to the first polymerization reactor is injected into the reactor at two locations with approximately equal reactor volumes between each injection location. The fresh feed is controlled with each injector receiving half of the total fresh feed mass flow. The catalyst components are injected into the polymerization reactor separate from the fresh feeds, if there is a fresh feed added. The primary catalyst component feed is computer controlled to maintain the reactor monomer conversion at the specified value, and to produce a polymer with a desired MI, density, and melt strength. The cocatalyst component(s) is/are fed based on molar ratios to the primary catalyst component. Immediately following each first reactor feed injection location, the feed streams are mixed with the circulating polymerization reactor contents with static mixing elements. The contents of the first reactor are continuously circulated through heat exchangers responsible for removing much of the heat of reaction and with the temperature of the coolant side responsible for maintaining an isothermal reaction environment at the specified temperature. Circulation around the first reactor loop is provided by a pump.

The second reactor effluent enters a zone where it is deactivated with the addition of and reaction with a suitable reagent (water). Antioxidant addition can also occur at this same addition point. Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

The reactor stream feed data flows that correspond to the values in Table 2. The data are presented such that the complexity of the solvent recycle system is accounted for and the reaction system can be treated more simply as a once through flow diagram.

### Chain Transfer Constant Calculations

Chain transfer constant were calculated using the version of the Mayo equation shown in Equation 7 where Mn₀ is the Mn without any hydrogen added to the reactor, the H₂ and ethylene concentrations are liquid phase concentrations, and c_{CTH} is the ratio of the hydrogenolysis rate constant over the propagation rate constant. The reactor volume was 3.414 L, the liquid phase ethylene concentration was estimated to be 0.539 M, and the estimated hydrogen concentrations are: 1.17 mM, 2.31 mM, 4.53 mM, 8.74 mM, and 16.3 mM for 10, 20, 40, 80, and 160 mmol H₂, respectively. The Mn values were calculated using Equation 8 for each loading of hydrogen. The Solver feature of MS Excel was used to vary the value of c_{CTH} to minimize the sum of the squared deviations of the calculated Mn values versus the experimental Mn values for all the hydrogen loadings simultaneously.

$$\frac{1}{M n} = \frac{1}{M {n}_{0}} + {c}_{C T H} \frac{[ {H}_{2} ]}{28 \times [ ethylene ]} \qquad ( EQ . 8 )$$

### EXAMPLES

One or more features of the present disclosure are illustrated in view of the examples as follows.

The following catalysts were utilized in one or more of the examples described subsequently in more detail:

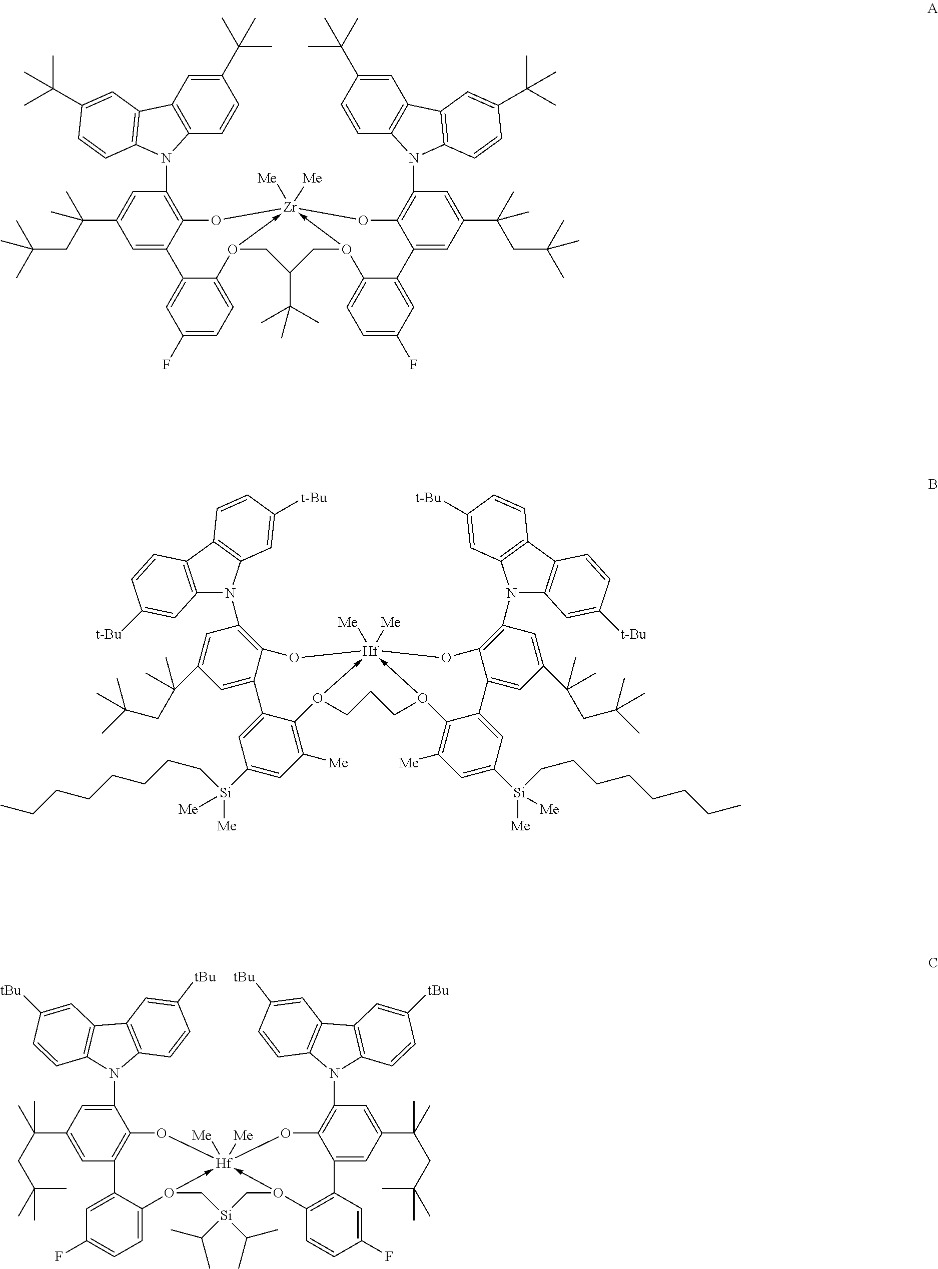

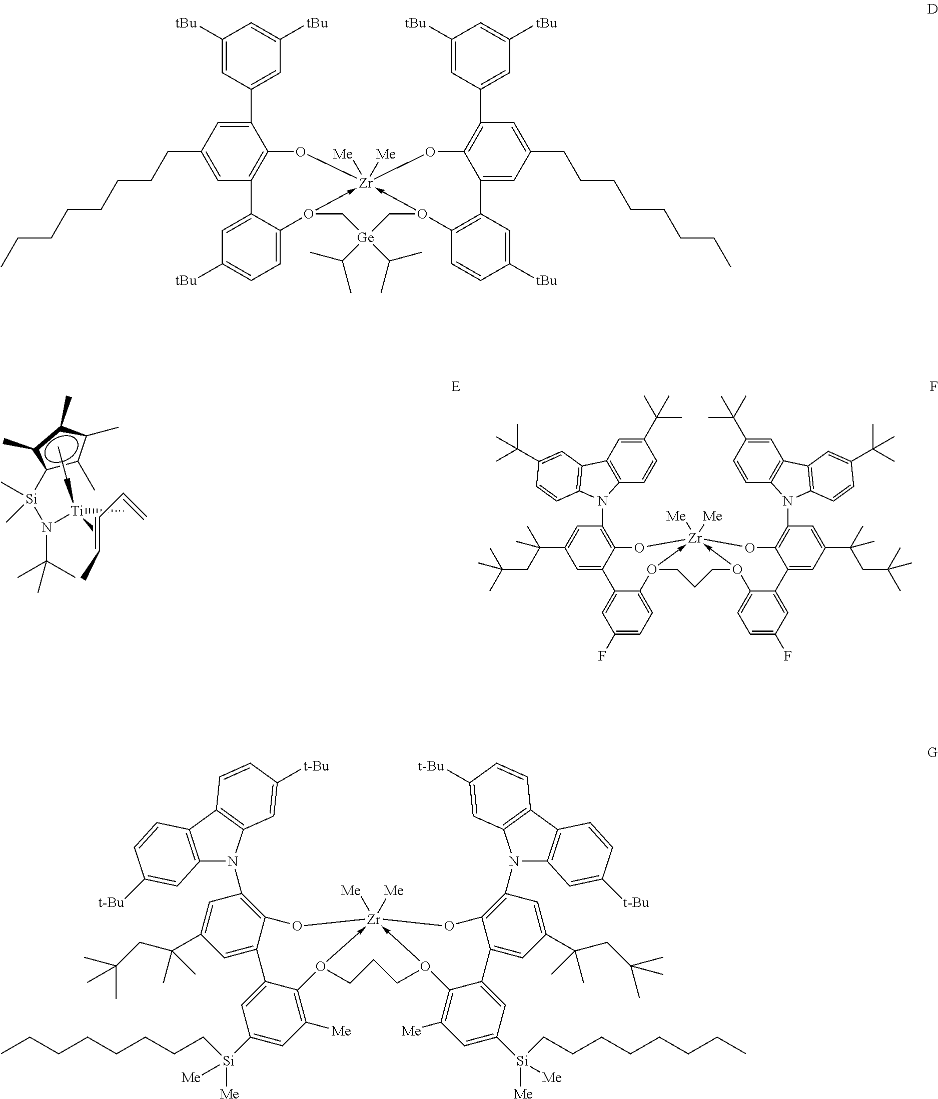

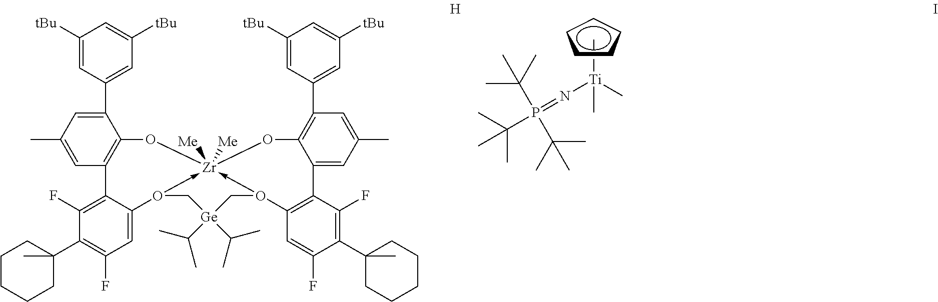

### Example 1: Preparation of Compositions 1-8

Multimodal Ethylene-based Polymer Compositions 1-8, which are described according to the one or more embodiments of the detailed description, were prepared by a process utilizing the catalysts and reactors described below. The reactor and feed conditions for the synthesis of Composition 1 is provided in Table 1, Composition 2 in Table 2 and Composition 3-7 in Table 3.

TABLE 1
Conditions for the Synthesis of Composition 1 using Reactor Setup 1

| Parameters | units | Composition 1 |
|---|---|---|
| Comonomer type | Type | 1-octene |
| First Reactor Feed Solvent/Ethylene | g/g | 7.8 |
| Mass Flow Ratio | | |
| First Reactor Feed Comonomer/ | g/g | 24.23 |
| Ethylene Mass Flow Ratio | | |
| First Reactor Feed Hydrogen/ | g/g | 2.3E−05 |
| Ethylene Mass Flow Ratio | | |
| First Reactor H2 Feed | mol % | 0.03 |
| First Reactor Temperature | ° C. | 190.0 |
| First Reactor Pressure | barg | 28 |
| First Reactor Ethylene Conversion | % | 87.2 |
| First Reactor Catalyst-1 Type | Type | A |
| First Reactor Co-Catalyst 1 Type | Type | [HNMe(C18H37)]2 |
| | | [B(C6F5)4] |
| First Reactor Co-Catalyst 2 Type | Type | MMAO3-A |
| First Reactor Co-Catalyst 1 to | Ratio | 1.2 |
| Catalyst Molar Ratio | | |
| First Reactor Co-Catalyst 2 to | Ratio | 27.2 |
| Catalyst Molar Ratio | | |
| First Reactor Residence Time | min | 4.0 |
| Percentage of Total Ethylene Feed to | wt% | 11 |
| First Reactor | | |
| Second Reactor Feed Solvent/ | g/g | 0 |
| Ethylene Mass Flow Ratio | | |
| Second Reactor Feed Comonomer/ | g/g | 0 |
| Ethylene Mass Flow Ratio | | |
| Second Reactor Feed Hydrogen/ | g/g | 0 |
| Ethylene Mass Flow Ratio | | |
| Second Reactor H2 Feed | mol % | 0 |
| Second Reactor Temperature | ° C. | 190 |
| Second Reactor Pressure | barg | 28 |
| Second Reactor Ethylene Conversion | % | 78.1 |
| Second Reactor Catalyst Type | Type | C |
| Second Reactor Co-Catalyst 1 Type | Type | [HNMe(C18H37)]2 |
| | | [B(C6F5)4] |
| Second Reactor Co-Catalyst 2 Type | Type | MMAO3-A |
| Second Reactor Co-Catalyst 1 to | Ratio | 0.18 |
| Catalyst Molar Ratio | | |
| Second Reactor Co-Catalyst 2 to | Ratio | N/A |
| Catalyst Molar Ratio | | |
| Second Reactor Residence Time | min | 3.11 |

TABLE 2
Conditions for the Synthesis of Composition 2 using Reactor Setup 1

| Multimodal Ethylene- | | |
|---|---|---|
| based Polymer | | |
| Composition | Unit | Composition 2 |
| Comonomer Type | | 1-octene |
| Catalyst 1 | | G |
| Catalyst 2 | | C |
| Catalyst 1 | mol % | 55 |
| Catalyst 2 | mol % | 45 |
| Cocatalyst | — | [HNMe(C₁₈H₃₇)]₂[B(C₆F₅)₄] |
| Cocatalyst:catalyst equiv | ratio | 11.3 |
| Reactor 1 Solvent/ | (kg/kg) | 5.3 |
| Monomer Ratio | | |
| Reactor 1 Temp | (° C.) | 190 |
| Reactor 1 Octene/Ethylene | (kg/kg) | 0.37 |
| Flow Ratio | | |
| Reactor 1 H2 Feed mol % | (mol %) | 0.3 |
| Reactor 1 Ethylene | (%) | 88.7 |
| conversion | | |
| Reactor 1 residence time | (min) | 8.1 |

TABLE 3
Conditions for the Synthesis of Compositions 3 to 6 using Reactor Setup 2.

| Parameter | units | 3 | 4 | 5 | 6 |
|---|---|---|---|---|---|
| Comonomer type | Type | 1-octene | 1-octene | 1-octene | 1-octene |
| First Reactor Feed Solvent/ | g/g | 5.1 | 5.1 | 5.4 | 5.4 |
| Ethylene Mass Flow Ratio | | | | | |
| First Reactor Feed | g/g | 0.265 | 0.266 | 0.072 | 0.040 |
| Comonomer/Ethylene | | | | | |
| Mass Flow Ratio | | | | | |
| First Reactor Feed | g/g | 1.9E−05 | 1.9E−05 | 8.0E−05 | 1.2E−04 |
| Hydrogen/Ethylene Mass | | | | | |
| Flow Ratio | | | | | |
| First Reactor H2 Feed | mol % | 0.03 | 0.03 | 0.12 | 0.1 |
| First Reactor Temperature | ° C. | 190 | 191 | 190 | 191 |
| First Reactor Pressure | barg | 41 | 41 | 41 | 41 |
| First Reactor Ethylene | % | 80.4 | 80.7 | 86.1 | 86.9 |
| Conversion | | | | | |
| First Reactor Catalyst-1 | Type | G | G | A | A |
| Type | | | | | |
| First Reactor Co-Catalyst 1 | Type | MMAO-7 | MMAO-7 | [HNMe(C₁₈H₃₇)]₂ | [HNMe(C₁₈H₃₇)]₂ |
| Type | | | | [B(C₆F₅)₄] | [B(C₆F₅)₄] |
| First Reactor Co-Catalyst 2 | Type | None | None | MMAO-3A | MMAO-3A |
| Type | | | | | |
| First Reactor Co-Catalyst 1 | Ratio | 2750 | 2350 | 1.3 | 1.1 |
| to Catalyst Molar Ratio | | | | | |
| First Reactor Co-Catalyst 2 | Ratio | — | — | 147.7 | 97.5 |
| to Catalyst Molar Ratio | | | | | |
| First Reactor Residence | min | 7.5 | 7.5 | 6.7 | 6.6 |
| Time | | | | | |
| Percentage of Total | wt % | 95.5 | 96.2 | 99.3 | 99.3 |
| Ethylene Feed to First | | | | | |
| Reactor | | | | | |
| Second Reactor Feed | g/g | 15.6 | 18.6 | 101.9 | 90.1 |
| Solvent/Ethylene Mass | | | | | |
| Flow Ratio | | | | | |
| Second Reactor Feed | g/g | 0.69 | 0.83 | 0.68 | 0.34 |
| Comonomer/Ethylene | | | | | |
| Mass Flow Ratio | | | | | |
| Second Reactor Feed | g/g | 0 | 0 | 0 | 0 |
| Hydrogen/Ethylene Mass | | | | | |
| Flow Ratio | | | | | |
| Second Reactor H2 Feed | mol % | 0 | 0 | 0 | 0 |
| Second Reactor | ° C. | 190 | 190 | 190 | 190 |
| Temperature | | | | | |
| Second Reactor Pressure | barg | 42 | 42 | 42 | 42 |
| Second Reactor Ethylene | % | 57.4 | 58.5 | 60.2 | 57.9 |
| Conversion | | | | | |
| Second Reactor Catalyst | Type | H | H | C | C |
| Type | | | | | |
| Second Reactor Co-Catalyst | Type | None | None | [HNMe(C₁₈H₃₇)]₂ | [HNMe(C₁₈H₃₇)]₂ |
| 1 Type | | | | [B(C₆F₅)₄] | [B(C₆F₅)₄] |
| Second Reactor Co-Catalyst | Type | None | None | None | None |
| 2 Type | | | | | |
| Second Reactor Co-Catalyst | Ratio | N/A | N/A | 20.7 | 20.7 |
| 1 to Catalyst Molar Ratio | | | | | |
| Second Reactor Co-Catalyst | Ratio | N/A | N/A | N/A | N/A |
| 2 to Catalyst Molar Ratio | | | | | |
| Second Reactor Residence | min | 6.7 | 6.7 | 6.1 | 6.0 |
| Time | | | | | |

### Example 2: Preparation of Comparative Compositions C1-C3

Comparative Compositions C1-C3 were prepared by a process utilizing the catalysts and reactors described below.

All raw materials (monomer and comonomer) and the process solvent (a narrow boiling range high-purity isoparaffinic solvent, Isopar-E) were purified with molecular sieves before introduction into the reaction environment. Hydrogen was supplied pressurized as a high purity grade and was not further purified. The reactor monomer feed stream was pressurized via a mechanical compressor to above reaction pressure. The solvent and comonomer feed was pressurized via a pump to above reaction pressure. The individual catalyst components were manually batch diluted with purified solvent and pressured to above reaction pressure. All reaction feed flows were measured with mass flow meters and independently controlled with computer automated valve control systems. The reactor and feed conditions for the synthesis of Comparative Compositions C1-C3 are provided in Table 5.

TABLE 4
Reactor and Feed Conditions for the Synthesis of
Comparative Comp. C1-C3.

| Parameters | units | C1 | C2 | C3 |
|---|---|---|---|---|
| Reactor setup | Type | 1 | 1 | 1 |
| Reactor Conf. | Type | Single | Single | Single |
| Comonomer type | Type | 1-octene | 1-octene | 1-octene |
| First Reactor Feed Solvent/ | g/g | 7.4 | 7.8 | 7.8 |
| Ethylene Mass Flow Ratio | | | | |
| First Reactor Feed | g/g | 2.9 | 3.6 | 4.1 |
| Comonomer/ | | | | |
| Ethylene Mass Flow Ratio | | | | |
| First Reactor | g/g | 0.00 | 0.00 | 0.00 |
| Feed Hydrogen/ | | | | |
| Ethylene Mass Flow Ratio | | | | |
| First Reactor H2 Feed | mol % | 2.5E−02 | 8.0E−03 | 7.9E−03 |
| First Reactor Temperature | ° C. | 165.0 | 190.1 | 179.0 |
| First Reactor Pressure | barg | 28.0 | 28.0 | 28.0 |
| First Reactor Ethylene | % | 91.9 | 95.7 | 95.7 |
| Conversion | | | | |
| First Reactor | Type | A | A | A |
| Catalyst-1 Type | | | | |
| First Reactor Co-Catalyst | Type | [HNMe(C18H37)]2 [B(C6F5)4] | | |
| 1 Type | | | | |
| First Reactor Co-Catalyst | Type | MMAO3- | MMAO3- | MMAO3- |
| 2 Type | | A | A | A |
| First Reactor | Ratio | 1.2 | 1.2 | 1.2 |
| Co-Catalyst 1 to | | | | |
| Catalyst Molar Ratio | | | | |
| First Reactor | Ratio | 102.7 | 7.9 | 31.0 |
| Co-Catalyst 2 to | | | | |
| Catalyst Molar Ratio | | | | |
| First Reactor | min | 4.9 | 4.3 | 4.4 |
| Residence Time | | | | |
| Percentage of Total | wt % | 11.4 | 11.0 | 11.1 |
| Ethylene Feed | | | | |
| to First Reactor | | | | |

### Example 3: Comparative Compositions C4-C8

Comparative compositions C4 and C5 are ethylene-based polymers produced via a high-pressure free-radical polymerization process. Comparative composition C6 is an ethylene-based polymer produced in a single reactor with a single catalyst. Comparative compositions C7 and C8 are bimodal ethylene-based polymers produced in a dual reactor system having a single catalyst in each reactor.

### Example 4: Preparation of Comparative Compositions C9-C19

Comparative Compositions 9-19 were prepared by a process utilizing the catalysts and reactors described below.

TABLE 5
Reactor and Feed Conditions for the Synthesis of Comparative Comp. C9-C19.

| | C9 | C10 | C11 | C12 | C13 | C14 | C15 | C16 | C17 | C18 | C19 |
|---|---|---|---|---|---|---|---|---|---|---|---|
| Reactor Conf. | Dual | Dual | Dual | Dual | Dual | Dual | Dual | Dual | Dual | Dual | Dual |
| Reactor setup | 1 | 1 | 1 | 1 | 1 | 1 | 1 | 1 | 1 | 1 | 1 |
| Comonomer Type | 1-octene | | | | | | | | | | |
| Reactor 1 Temp (° C.) | 123 | 160 | 160 | 210 | 210 | 210 | 210 | 210 | 210 | 225 | 225 |
| Reactor 1 Solvent/ | 6.0 | 25.5 | 25.4 | 6.0 | 6.0 | 6.0 | 6.0 | 6.3 | 6.3 | 6.3 | 6.3 |
| Monomer Ratio | | | | | | | | | | | |
| (kg/kg) | | | | | | | | | | | |
| Reactor 1 | 0.3 | 32.4 | 33.2 | 0.5 | 0.5 | 0.5 | 0.5 | 0.4 | 0.4 | 0.4 | 0.4 |
| Comonomer/Monomer | | | | | | | | | | | |
| Mass Flow Ratio | | | | | | | | | | | |
| (kg/kg) | | | | | | | | | | | |
| Reactor 1 | 1.4E− | 0.0E+00 | 1.8E− | 4.3E− | 4.3E− | 4.3E− | 4.3E− | 7.2E− | 7.2E− | 7.2E− | 7.2E− |
| Hydrogen/Ethylene | 05 | | 05 | 05 | 05 | 05 | 05 | 06 | 06 | 06 | 06 |
| Mass Feed Ratio | | | | | | | | | | | |
| (kg/kg) | | | | | | | | | | | |
| Reactor 1 Hydrogen | 0.02 | 0 | 0.03 | 0.06 | 0.06 | 0.06 | 0.06 | 0.01 | 0.01 | 0.01 | 0.01 |
| Feed (mol %) | | | | | | | | | | | |
| Reactor 1 Ethylene | 71.9 | 31.2 | 30.3 | 97.3 | 97.3 | 97.8 | 97.4 | 96.8 | 96.8 | 97.9 | 98.1 |
| Conversion (%) | | | | | | | | | | | |
| Reactor 1 Cocatalyst | [HN(CH₃)(C₁₈H₃₇)₂]⁺[B(C₆F₅)]⁻ | | | | | | | | | | |
| Reactor 1 Cocatalyst | 1.2 | 1.3 | 1.2 | 1.2 | 1.2 | 1.2 | 1.2 | 1.2 | 1.2 | 1.5 | 1.6 |
| equiv | | | | | | | | | | | |
| Reactor 2 Temp (° C.) | 190 | 160 | 160 | 170 | 170 | 170 | 170 | 170 | 170 | 170 | 170 |
| Reactor 2 | 4.7 | 4.1 | 4.2 | 5.3 | 5.3 | 5.3 | 5.3 | 5.3 | 5.3 | 5.2 | 5.2 |
| Solvent/Monomer | | | | | | | | | | | |
| Ratio (kg/kg) | | | | | | | | | | | |
| Reactor 2 Comonomer/ | 0.2 | 0.1 | 0.1 | 0.2 | 0.2 | 0.1 | 0.1 | 0.2 | 0.2 | 0.2 | 0.2 |
| Monomer Mass Flow | | | | | | | | | | | |
| Ratio (kg/kg) | | | | | | | | | | | |
| Reactor 2 Hydrogen/ | 5.1E− | 4.8E−04 | 3.1E− | 3.6E− | 3.6E− | 8.8E− | 1.1E− | 4.1E− | 3.5E− | 3.7E− | 3.1E− |
| Monomer Mass Flow | 04 | | 04 | 04 | 04 | 04 | 03 | 04 | 04 | 04 | 04 |
| Ratio (kg/kg) | | | | | | | | | | | |
| Reactor 2 Hydrogen | 0.71 | 0.67 | 0.43 | 0.89 | 0.89 | 1.15 | 1.33 | 0.92 | 0.79 | 0.76 | 0.76 |
| Feed (mol %) | | | | | | | | | | | |
| Reactor 2 Ethylene | 95.1 | 88.9 | 86.1 | 96.1 | 96.1 | 97.2 | 96.4 | 96.7 | 96.7 | 98.5 | 98.4 |
| Conversion (%) | | | | | | | | | | | |
| Reactor 1 Catalyst | E | D | D | F | F | F | F | A | A | A | A |
| Reactor 2 Catalyst | B | D | D | C | C | C | C | C | C | C | C |
| Reactor 2 Cocatalyst | [HN(CH₃)(C₁₈H₃₇)₂]⁺[B(C₆F₅)]⁻ | | | | | | | | | | |
| Reactor 2 Cocatalyst | 4.6 | 1.2 | 1.2 | 1.2 | 1.2 | 1.2 | 1.2 | 1.4 | 1.2 | 1.2 | 1.2 |
| equiv | | | | | | | | | | | |

TABLE 6
Evaluation of Catalysts A, C, D, E, H and G in a Semi-Batch Reactor

| | Reaction | | | | 1- | 1- | | | |
|---|---|---|---|---|---|---|---|---|---|
| | Temp. | Yield | Efficiency | Mw | Octene | Octene | Tm | Reactivity | Reactivity |
| Catalyst | (° C.) | (g) | (kgPE/gM) | (kg/mol) | wt % | mol % | (° C.) | ratio r₁* | ratio r₂* |
| A | 160 | 11.7 | 1,781 | 38.4 | 13.5 | 3.75 | 104 | 10.5 | 0.09 |
| A | 190 | 7.2 | 526 | 32.8 | 12.0 | 3.3 | 107 | 12.0 | 0.08 |
| D | 160 | 48.2 | 813 | 1,695 | 15.0 | 4.23 | 96 | 9.3 | 0.11 |
| D | 190 | 13.0 | 543 | 570 | 9.5 | 2.56 | 104 | 15.6 | 0.06 |
| C | 160 | 40.6 | 2,275 | 893 | 16.7 | 4.77 | 87 | 8.2 | 0.12 |
| C | 190 | 22.7 | 339 | 559 | 12.7 | 3.51 | 96 | 11.3 | 0.09 |
| E | 160 | 10.5 | 110 | 145 | 8.0 | 2.1 | 110 | 19.1 | 0.05 |
| H | 160 | 14.4 | 548 | 542 | 18.0 | 5.2 | 86 | 7.5 | 0.13 |
| H | 190 | 19.6 | 195 | 277 | 15.8 | 4.5 | 91 | 8.8 | 0.11 |
| G | 160 | 12.7 | 2,320 | 146 | 0.4 | 0.10 | 128 | 270 | 0.004 |
| G | 190 | 9.0 | 1,052 | 104 | 0.2 | 0.05 | 129 | 300 | 0.003 |

Conditions: 160° C. runs: 320 psi ethylene, 60 g 1-octene, 0 H₂, 1250 mL Isopar E solvent. 190° C. runs: 410 psi ethylene, 65 g 1-octene, 0 H₂, 1250 mL Isopar E solvent. All runs: mol fraction of ethylene in solution = 0.709.

The reactivity ratio r₁ is the reactivity ratio for a monomer insertion after ethylene, and is calculated using the Mayo-Lewis equation:

$${F}_{1} = \frac{{r}_{1} {f}_{1}^{2} + {f}_{1} {f}_{2}}{{r}_{1} {f}_{1}^{2} + 2 {f}_{1} {f}_{2} + {r}_{2} {f}_{2}^{2}} \qquad ( EQ . 9 )$$

In Equation 9, r₂ is the reactivity ratio for a monomer insertion after the comonomer (here 1-octene), f₁ is the mol fraction of ethylene in the feed, f₂ is the mol fraction of comonomer (1-octene) in the feed, and F₁ is the mol fraction of ethylene in the polymer.

$${F}_{1} = 1 - {F}_{2} \qquad ( EQ . 10 )$$

In Equation 10, F₂ is the mol fraction of 1-octene in the polymer. This value can be obtained experimentally by GPC analysis of the polymer.

The Mayo-Lewis equation can be solved using the GRG Nonlinear solving method available in Microsoft Excel to find the r₁ and r₂ values that give the best fit.

### Example 5: Analysis of Compositions 1-6 and Comparative Compositions 1-19

In Example 5, the Multimodal Ethylene-based Polymer Compositions 1-6 and Comparative Compositions 1-19 were tested for the properties listed in Tables 8-10, according to the test methods described herein.

TABLE 7
Analysis of Compositions 1-6 and Comparative Compositions 1-19.

| | | Absolute GPC | | | | | | | | |
|---|---|---|---|---|---|---|---|---|---|---|
| | | Mn* | Mw* | Mz* | Mw/ | Mz/ | Conventional GPC | | | MW_{(abs)}/ |
| | Catalyst | (kDa) | (kDa) | (kDa) | Mn* | Mw** | Mn** | Mw** | Mz** | MW_{(GPC)} |
| C1 | A | 20.2 | 64.7 | 549.3 | 2.6 | 8.5 | 20.3 | 53.2 | 141.5 | 1.21 |
| C2 | A | 18.7 | 62.1 | 261.9 | 2.7 | 4.2 | 18.8 | 50.7 | 121.2 | 1.21 |
| C3 | A | 22.7 | 77.9 | 386.3 | 2.8 | 5.0 | 22.8 | 63.2 | 146.1 | 1.22 |
| C4 | — | 13.6 | 265.9 | 6918.1 | 19.6 | 26.0 | 12.9 | 104.8 | 555.8 | 2.2 |
| C5 | — | 16.2 | 490.4 | 5367.9 | 30.3 | 10.9 | 14.9 | 186.0 | 888.1 | 2.6 |
| C6 | Ziegler- | 26.5 | 126.9 | 613.9 | 4.8 | 4.8 | 26.9 | 121.1 | 508.2 | 1.0 |
| | Natta | | | | | | | | | |
| C9 | E/B | 45.2 | 111.3 | 228.4 | 2.3 | 2.1 | 46.1 | 106.8 | 219.5 | 1.04 |
| C10 | D/D | 33.1 | 118.1 | 1094.6 | 3.7 | 9.3 | 33.3 | 124.5 | 1692 | 0.96 |
| C11 | D/D | 50 | 136.4 | 645.7 | 2.8 | 4.7 | 48.6 | 135.8 | 874.4 | 1 |
| C12 | F/C | 27.2 | 89 | 298.5 | 2.8 | 3.4 | 25.6 | 72.6 | 147.2 | 1.23 |
| C13 | F/C | 28.7 | 88.8 | 280.6 | 2.8 | 3.2 | 25.5 | 72.1 | 143.2 | 1.23 |
| C14 | F/C | 25.4 | 93.4 | 348.6 | 3.1 | 3.7 | 24 | 75.2 | 162.3 | 1.24 |
| C15 | F/C | 26.3 | 89.1 | 310 | 2.9 | 3.5 | 24.2 | 70.9 | 146.6 | 1.26 |
| C16 | A/C | 20.8 | 87.3 | 237.7 | 3.5 | 2.7 | 19.6 | 68.5 | 139.8 | 1.27 |
| C17 | A/C | 20 | 89.9 | 236.4 | 3.7 | 2.6 | 18.9 | 70.1 | 149 | 1.28 |
| C18 | A/C | 20.6 | 88.4 | 208.1 | 3.5 | 2.4 | 20.1 | 69.8 | 138.8 | 1.27 |
| C19 | A/C | 22.6 | 88.1 | 200.6 | 3.3 | 2.3 | 21 | 69.8 | 136.7 | 1.26 |
| 1 | A/C | 21.0 | 98.3 | 320.6 | 4.7 | 3.3 | 20.8 | 81.8 | 357.4 | 1.2 |
| 2 | G/C | 29.2 | 87.8 | 240.2 | 3.0 | 2.7 | 32.8 | 87.0 | 255.6 | 1.01 |
| 3 | G/H | 26.0 | 86.4 | 114.4 | 3.3 | 1.3 | 29.3 | 80.0 | 215.0 | 1.08 |
| 4 | G/H | 22.1 | 82.1 | 294.4 | 3.7 | 3.6 | 28.9 | 79.6 | 226.9 | 1.03 |
| 5 | A/C | 20.7 | 98.8 | 937.3 | 4.8 | 9.5 | 20.4 | 76.2 | 317.8 | 1.3 |
| 6 | A/C | 21.5 | 87.6 | 930.4 | 4.1 | 10.6 | 19.0 | 66.5 | 295.1 | 1.3 |

*Values from absolute GPC analysis
**Values from conventional GPC analysis

TABLE 8
Analysis of Compositions 1-6 and Comparative Compositions 1-19.

| | Catalyst | C8 wt % | Density (g/cc) | V0.1/V100 |
|---|---|---|---|---|
| C1 | A | 18 | 0.9058 | 4 |
| C2 | A | 16.4 | 0.9076 | 3.7 |
| C3 | A | 15.2 | 0.9095 | 9.7 |
| C4 | — | — | 0.9200 | 49 |
| C5 | — | — | 0.9190 | 21 |
| C6 | Ziegler-Natta | 8.1 | 0.9200 | 5 |
| C7 | Molecular | 7.9 | 0.9230 | 6.4 |
| C8 | Molecular | 11.4 | 0.9160 | 6.8 |
| C9 | E/B | 7.1 | 0.9243 | 4.7 |
| C10 | C/C | 8.1 | 0.9197 | 6.2 |
| C11 | C/C | 6.8 | 0.9176 | 4.5 |
| C12 | F/C | — | 0.9048 | 15.2 |
| C13 | F/C | — | 0.9045 | 14.8 |
| C14 | F/C | — | 0.9049 | 19.6 |
| C15 | F/C | — | 0.9043 | 15.4 |
| C16 | A/C | — | 0.9041 | 17.0 |
| C17 | A/C | — | 0.9044 | 19.3 |
| C18 | A/C | — | 0.9035 | 18.6 |
| C19 | A/C | — | 0.9038 | 16.4 |
| 1 | A/C | 12.1 | 0.9140 | 17 |
| 2 | G/C | 0.0 | 0.9516 | 4.8 |
| 3 | G/H | 2.1 | 0.9369 | 5.1 |
| 4 | G/H | 1.9 | 0.9372 | — |
| 5 | A/C | 4.9 | 0.9337 | 17.5 |
| 6 | A/C | 3.4 | 0.9390 | 11.4 |

TABLE 9
Analysis of Compositions 1-6 and Comparative Compositions 1-19.

| | | | | | | Vinyl end | | |
|---|---|---|---|---|---|---|---|---|
| | | CDF LS | | | | group | | |
| | | 500,000 | Melt | | Activation | count | | |
| | | g/mol | strength | Drawability | Energy | per 1000 | | |
| | Catalyst | cutoff % | (CN) | (mm/s) | (kJ/mol) | C | MI | I10/12 |
| C1 | A | 7.3 | 2.7 | 243 | 49.0 | — | 6.5 | 10.7 |
| C2 | A | 5.7 | 1.3 | 259 | 50.0 | 0.545 | 8.0 | 10.4 |
| C3 | A | 5.2 | 4.3 | 221 | 53.0 | 0.464 | 1.8 | 12.8 |
| C4 | — | 57.1 | 11.7 | 228 | 52.0 | — | 1.8 | 14.5 |
| C5 | — | 66.6 | 22.5 | 68 | 48.0 | — | 0.23 | 17.3 |
| C6 | Ziegler-Natta | 29.5 | 3.3 | 183 | 30.0 | — | 1.0 | 8.2 |
| C7 | Molecular | 19.3 | 4.3 | 176 | 33.2 | — | 0.85 | 8 |
| C8 | Molecular | 12.9 | 4.0 | 172 | 36.3 | — | 0.97 | 8.5 |
| C9 | E/B | 7.1 | 4.3 | 181 | 32.0 | 0.0360 | 0.86 | 7.1 |
| C10 | D/D | 44.0 | 2.2 | 150 | 33.3 | 0.0120 | 3.7 | 6.8 |
| C11 | D/D | 28.9 | 3.9 | 196 | 31.0 | 0.018 | 0.99 | 6.7 |
| C12 | F/C | 4.78 | 4.1 | 253 | 49.6 | 0.112 | 0.80 | 14.3 |
| C13 | F/C | 4.96 | 4.2 | 240 | 49.9 | 0.110 | 0.85 | 14.2 |
| C14 | F/C | 6.18 | 5.3 | 232 | 53.4 | 0.156 | 0.62 | 16.1 |
| C15 | F/C | 5.18 | 4.4 | 254 | 53.3 | 0.140 | 0.91 | 14.8 |
| C16 | A/C | 2.75 | 5.3 | 259 | 54.4 | 0.249 | 0.94 | 15.3 |
| C17 | A/C | 3.69 | 5.3 | 260 | 55.1 | 0.293 | 0.90 | 16.0 |
| C18 | A/C | 2.13 | 5.7 | 266 | 54.4 | 0.225 | 0.69 | 15.8 |
| C19 | A/C | 2.12 | 6.2 | 266 | 54.3 | 0.190 | 0.77 | 15.3 |
| 1 | A/C | 21 | 24.6 | 48 | 57 | 0.536 | 0.75 | 15.4 |
| 2 | G/C | 14 | 4.5 | 164 | 29 | 0.494 | 3.9 | 6.9 |
| 3 | G/C | 13 | 6.8 | 212 | 35 | 0.406 | 3.2 | 7.9 |
| 4 | G/C | 16 | 7.0 | 159 | — | 0.417 | 4.5 | 6.7 |
| 5 | A/C | 30 | 16.5 | 122 | 49 | 0.694 | 0.96 | 13.2 |
| 6 | A/C | 31 | 9.0 | 138 | 37 | 0.804 | 1.8 | 11.8 |

TABLE 10
Constants for Chain Transfer to Hydrogen (cH2) for
Selected Catalysts at 160° C.

| Catalyst | cH2 |
|---|---|
| A | 0.015 |
| B | 0.036 |
| C | 0.011 |
| D | 0.015 |
| E | 0.19 |
| F | 0.013 |
| G | 0.016 |
| H | 0.307 |
| I | 0.534 |

As shown in Tables 7-9, Comparative examples C1-C3 are produced with a single biphenylphenol (BPP) catalyst A. While the polymers produced have high vinyl content, the lack of a higher molecular weight component made by a second catalyst leads to low melt strengths.

Comparative examples C16-C19 are produced with two BPP catalysts A and C in a dual reactor in series configuration. The level of hydrogen used in the reactor with BPP catalyst C (0.43-1.33 mol %) is quite high. This level of H₂ limits the ability of BPP catalyst to build molecular weight, as can be seen in the CDF LS 500,000 g/mol cutoff data, where these values range from 2.12-5.18%.

The inventive examples 1-6 are produced with two BPP catalysts in various reactor configurations including single reactor and dual reactor series, where the reactors were selected from CSTR, loop, and plug flow reactor types. The levels of hydrogen used to produce the inventive examples were much lower than those used to produce comparative examples 16-19.

For example, inventive example 2 used hydrogen levels in the range of 0.03-0.3 mol %. The lower levels of hydrogen enable BPP catalyst C or D, depending on the inventive example, produce higher molecular weight polymer. This is reflected in the CDF LS 500,000 g/mol cutoff data, where these values range from 13-310%, considerably higher than inventive examples 16-19 where higher levels of hydrogen were used.

Furthermore, inventive examples 1-6 have improved rheological properties, exhibiting melt strengths as high as 36 cN, whereas the melt strengths of comparative examples 1-3 and 16-19 are no higher than 6.2 cN, and that value was achieved for a lower MI polymer (MI=0.77 g/10 min).

1. A process of making a multimodal ethylene-based copolymer, comprising:
adding ethylene, at least one olefinic monomer, at least a first catalyst system, and less than 0.3 mol % hydrogen gas to a solution polymerization reactor to create an effluent feed at a reactor temperature of greater than or equal to 150° C., where mol % hydrogen is based on the moles of ethylene in the feed;
feeding the effluent feed and a second catalyst system to a second reactor absent fresh feed and absent hydrogen gas;
wherein:
the first catalyst system comprises a first procatalyst and a first activator; and the second catalyst system comprises a second procatalyst and optionally a second activator;
at least one of the first catalyst system and the second catalyst system have a chain transfer constant of from 0.005 to 1.0 and
wherein the multimodal ethylene-based copolymer comprises a high molecular weight fraction, computed by measuring an area fraction of a molecular weight chromatogram obtained from absolute molecular weights from low angle light scattering greater than 500,000 g/mol of from 8% to 50% based on the total percent of the multimodal ethylene-based copolymer.

2. The process of claim 1, wherein one of the first catalyst system and the second catalyst system are capable of producing a polymer with a native molecular weight of greater than 100,000 g/mol, wherein the polymer native molecular weight is measured in a single 1 Gal reactor in the presence of 1250 grams of ISOPAR-E, with an ethylene pressure of 320 psi, an 1-octene amount of 60 g, 0 H₂ and at a reactor temperature of at least 150° C.

3. The process of claim 2, wherein the other of the first catalyst system and the second catalyst system are capable of producing a polymer with a native molecular weight of less than 150,000 g/mol, wherein the polymer native molecular weight is measured in a single 1 Gal reactor in the presence of 1250 grams of ISOPAR-E, with an ethylene pressure of 320 psi, an 1-octene amount of 60 g, 0 H₂ and at a reactor temperature of at least 160° C.

4. The process of claim 1, wherein the first catalyst system is capable of producing a first polymer having a native molecular weight and the second catalyst system is capable of producing a second polymer having a native molecular weight with a difference of at least 80,000 g/mol from the native molecular weight of the first polymer.

5. The process of claim 1, wherein the solution polymerization reactor is a continuous stirred tank reactor, a loop reactor, or a plug flow reactor.

6. The process of claim 1, wherein the second polymerization reactor is non-agitated reactor.

7. The process of claim 6, wherein the non-agitated reactor is a plug flow reactor.

8. The process of claim 1, wherein at least one of the first catalyst and the second catalyst have a reactivity ratio of less than 20, wherein the reactivity ratio of the catalyst is measured in a single 1 Gal reactor with only the catalyst system in the presence of 1250 grams of ISOPAR-E, with a mol fraction of ethylene in solution of 0.709, 60 g 1-octene, and at a reactor temperature of at least 150° C.

9. The process of claim 1, wherein the multimodal ethylene-based copolymer further comprises a low molecular weight fraction, computed by measuring an area fraction of a molecular weight chromatogram obtained from absolute molecular weights from low angle light scattering less than 500,000 g/mol, is greater than or equal to 50% based on the total percent of the multimodal ethylene-based copolymer.

10. The process of claim 1, wherein the multimodal ethylene-based copolymer further comprises a high molecular weight fraction, computed by measuring an area fraction of a molecular weight chromatogram obtained from absolute molecular weights from low angle light scattering greater than 500,000 g/mol, is greater than or equal to 10% to 50% based on the total percent of the multimodal ethylene-based copolymer.

11. The process of claim 1, wherein the multimodal ethylene-based copolymer further comprises a high molecular weight fraction, computed by measuring an area fraction of a molecular weight chromatogram obtained from absolute molecular weights from low angle light scattering greater than 500,000, is from 20% to 50% based on the total percent of the multimodal ethylene-based copolymer.

12. The process of claim 1, wherein the multimodal ethylene-based copolymer has a density of from 0.900 g/cc to 0.940 g/cc measured according to ASTM D792.

13. The process of claim 1, wherein the multimodal ethylene-based copolymer has a melt strength of at least 5 cN and a melt index (I₂) of at least 0.5 g/10 minutes measured according to ASTM 1238 at 2.16 kg and 190° C.

14. The process of claim 1, wherein the multimodal ethylene-based copolymer has a melt strength (MS) that satisfies the following formula:
$$M S \geq \frac{x}{{I}_{2}} + y$$
wherein x is equal to 15, y is equal to 1, and I₂ is a melt index of the copolymer measured according to ASTM 1238 at 2.16 kg and 190° C.

15. The process of claim 1, where the V_{0.1}/V₁₀₀ value as determined by dynamic mechanical analysis is greater than 10.

16. The process of claim 1, wherein the first reactor temperature is from 160° C. to 200° C.

17. The process of claim 1, wherein the first procatalyst is selected from one of the following:

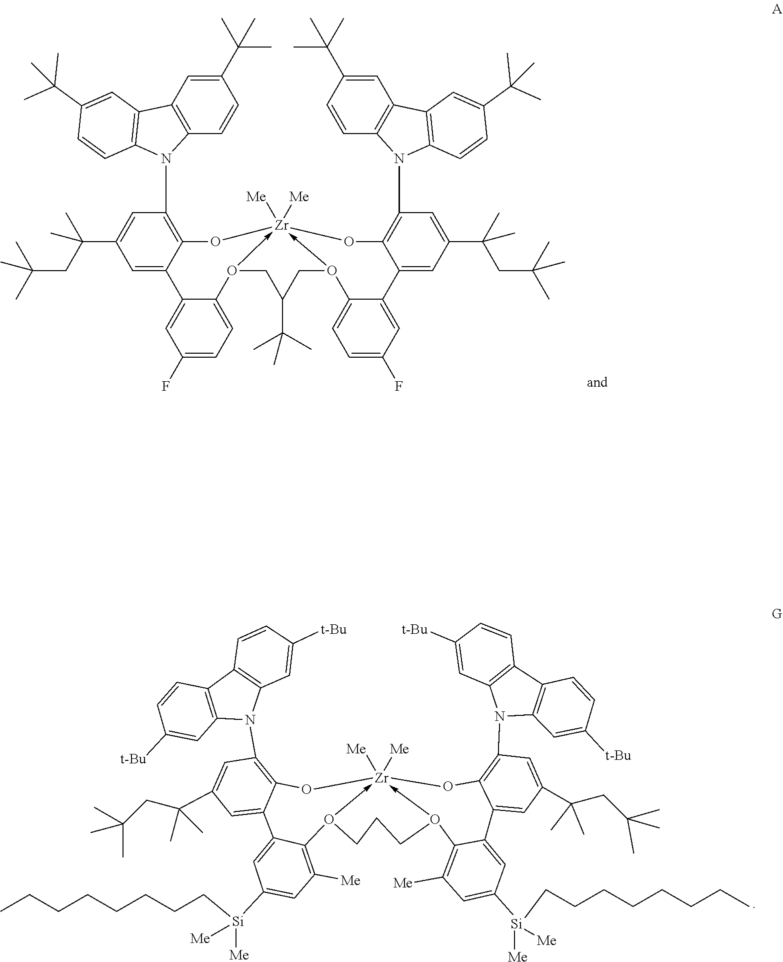

18. The process of claim 1, wherein the second procatalyst is selected from one of the following:

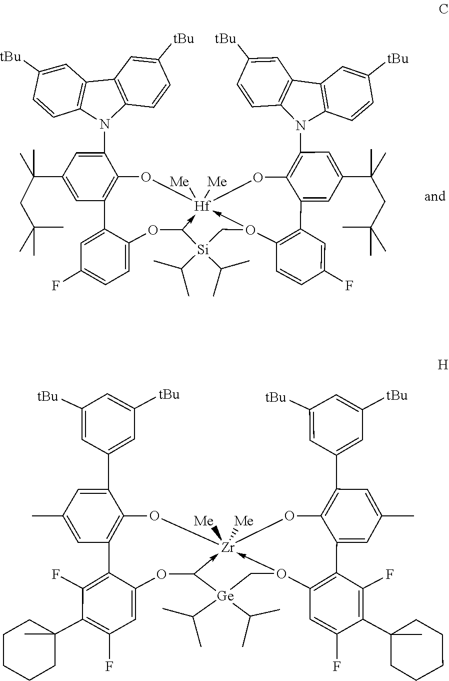

19. The process of claim 1, wherein the process further includes a third catalyst system.
